(19) United States
(12) Patent Application Publication
(10) Pub. No.: US 2021/0053430 A1
(43) Pub. Date: Feb. 25, 2021

(54) DEBRIS CONTAINMENT NET

(71) Applicant: Christopher M. Thomas, Monroe, MI (US)

(72) Inventor: Christopher M. Thomas, Monroe, MI (US)

(21) Appl. No.: 17/000,756

(22) Filed: Aug. 24, 2020

Related U.S. Application Data
(60) Provisional application No. 62/890,678, filed on Aug. 23, 2019.

(51) Int. Cl. B60J 11/04

(52) U.S. Cl. CPC B60J 11/04

(57) ABSTRACT

A debris containment device specifically adapted to prevent unwanted debris from falling off of a vehicle during transportation. The net is specifically adapted to connect to a vehicle and wraparound said vehicle so as to securely contain debris from a damaged vehicle. A net is provided with various connection portions configured to connect directly to the vehicle.

### CROSS REFERENCE TO RELATED APPLICATIONS

The application claims priority of U.S. Provisional Application No. 62/890,678 filed Aug. 23, 2019 which is incorporated herein by reference.

### TECHNICAL FIELD

The present specification generally relates to a net for use when transporting vehicles and, more specifically, a net specially adapted for vehicles to prevent debris from falling off during transportation.

### BACKGROUND

Towing vehicles after a crash or other accident is it requirement of having our roads operate smoothly and effectively. Damage vehicles are transported by means of a flatbed truck or other tow truck to repair shops or salvage yards on a daily basis. However, various road regulations require that all vehicle parts, components, and debris remain securely contained on the vehicle, or at least attached to the vehicle doing the transporting. Frequently however, debris from a damaged vehicle falls off of the damaged vehicle being transported. In some jurisdictions, law-enforcement may issue fines to tow truck drivers transporting damage vehicles if debris falls off of the damage vehicle. Debris such as damage to vehicle parts or decaying metal from a bird vehicle frequently falls off of damage vehicles and must be contained however no good measure exists to contain the damaged vehicles in the debris falling off therefrom.

Accordingly, a need exists for alternative means for securing debris when transporting vehicles.

### SUMMARY

The specification as described herein discloses a net specifically adapted to prevent unwanted debris from falling off of a vehicle during transportation. The net is specifically adapted to connect to a vehicle and wraparound said vehicle so as to securely contain debris from a damaged vehicle. The net is configured to be a one-time-only use and configured to be left with the vehicle after transportation is complete.

A debris containment device for securing debris on a damaged vehicle, the debris containment device including a main body, the main body including a layer of netting, a plurality of connection portions, at least one of the plurality of connection portions including a magnet configured to connect to the exterior of the vehicle, each connection portion including a grommet and a guide member and a cord extending around the outer peripheral edge of the main body, the cord extending though each guide member of each of the plurality of connection portions wherein the cord is configured to cinch the outer peripheral edge of the main body of the debris containment device so as to secure the debris containment device over a vehicle. In some embodiments, the guide is a cylindrical tube positioned parallel with the edge of the main body. In other embodiments, the the cord connects to a handle portion by extending though the handle potion, the handle configured to connect to the vehicle. In other embodiments, the main body includes secondary solid layer. In other variations, the secondary solid layer is plastic. In some embodiments, a basket is provided to store the debris containment device wherein the basket includes a metal plate thereby allowing a device to magnetically connect thereto.

These and additional features provided by the embodiments described herein will be more fully understood in view of the following detailed description, in conjunction with the drawings.

### BRIEF DESCRIPTION OF THE DRAWINGS

The embodiments set forth in the drawings are illustrative and exemplary in nature and not intended to limit the subject matter defined by the claims. The following detailed description of the illustrative embodiments can be understood when read in conjunction with the following drawings, where like structure is indicated with like reference numerals and in which:

FIG. 1 depicts an elevational view of the debris containment device and corresponding vehicle according to one or more embodiments shown and described herein;

FIG. 2 depicts a perspective cross sectional view of a portion of the connection portion and debris containment net according to one or more embodiments shown and described herein;

FIG. 3 depicts a perspective view of an alternative embodiment debris containment net according to one or more embodiment shown and described herein;

FIG. 4 depicts a side view of the debris containment device positioned over and secured to a vehicle according to one or more embodiments shown and described herein; and

FIG. 5 depicts a perspective view of the basket and corresponding debris containment net according to one or more embodiments shown and described herein.

### DETAILED DESCRIPTION

The specification as described herein discloses a net specifically adapted to prevent unwanted debris from falling off of a vehicle during transportation. The net is specifically adapted to connect to a vehicle and wraparound said vehicle so as to securely contain debris from a damaged vehicle. A net is provided with various connection portions configured to connect directly to the vehicle.

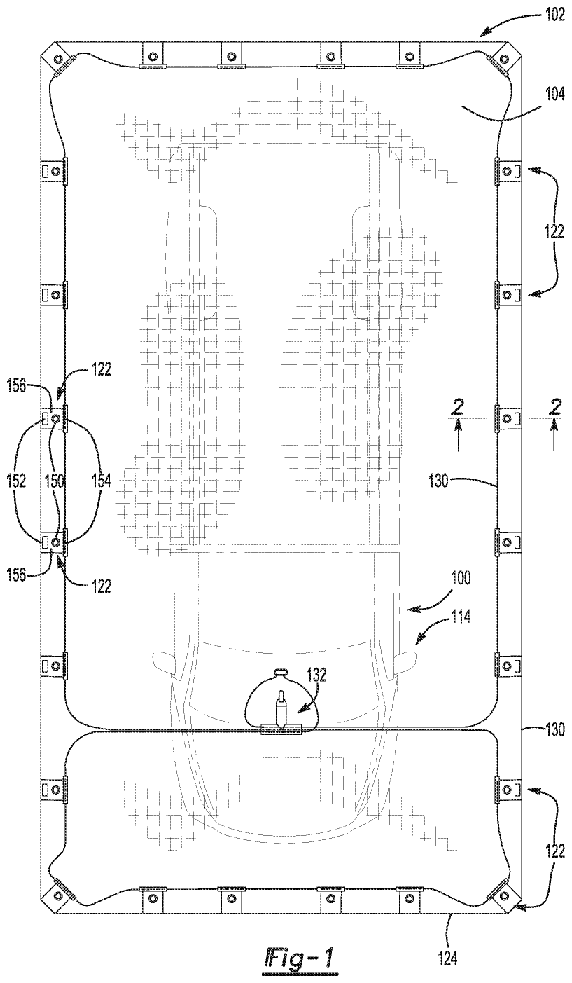

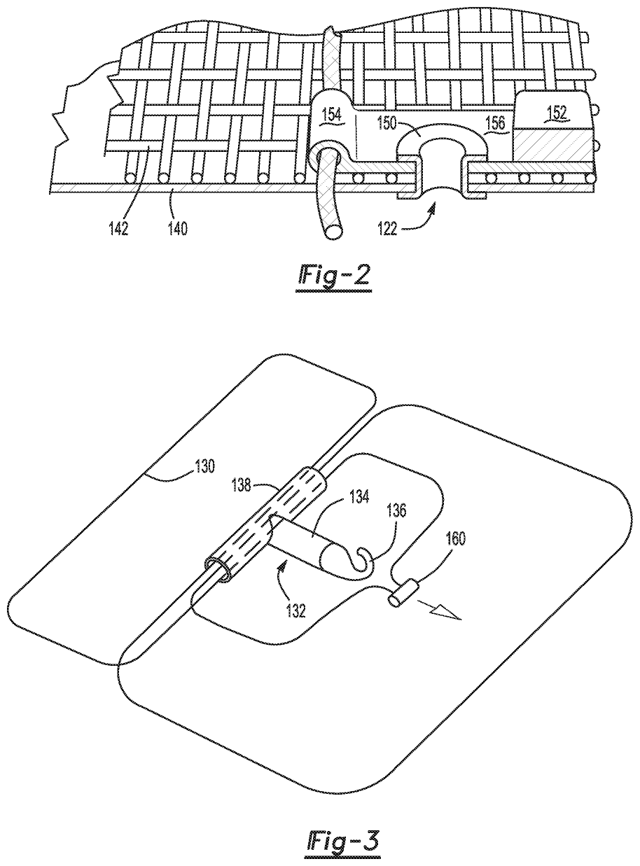

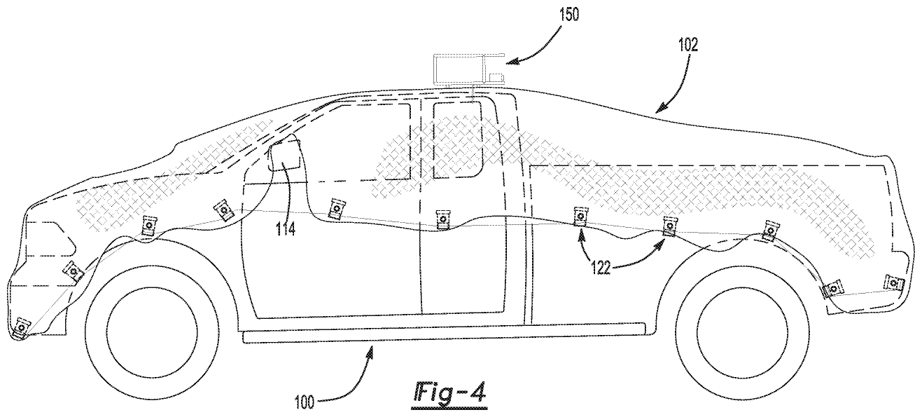

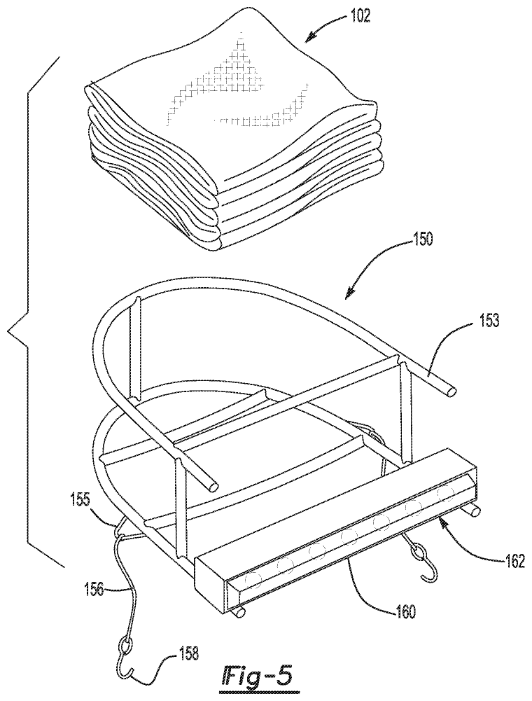

Referring now to FIGS. 1-5, a vehicle 100 is shown having a debris containment net 102. The vehicle 100 includes a pair of side mirrors 114. The vehicle 100 depicted is a traditional vehicle having four tires and a main body. However, it should be appreciated that the debris containment net 102 can be used with any similar vehicle in any condition. The net 102 includes a main body 104 and a plurality of connection portions 122. The connection portions 122 are positioned on the outer peripheral edge of the main body 104. The net 102 may further include a reinforced peripheral edge 124 to reinforce the outer edge of the main body 104 of the net 102. A wire or bungee cord may be provided so as to connect the connection portion is 122 to the vehicle.

The main body 104 includes the net 142 and a secondary layer 140. The net may be made of a plastic, fabric, nylon, polymer, polymer-like or other suitable resilient material. Similarly, the layer 140 may be made of a plastic, fabric, nylon, polymer, polymer-like or other suitable resilient material.

Each connection portion 122 includes a base 156, a grommet 150, a magnet 152 and a cylindrical connector 154. The base 156 is made of a hard plastic, polymer, canvas, coated canvas or other similar material suitable of supporting the grommet 150, the magnet 152 and the cylindrical connector 154. The grommet 150 is generally cylindrical in shape and extends through the base 156, the net 102 and the secondary layer 140. The grommet 150 is configured to connect to a cord, wire or bungee to secure the net 102 to the vehicle. The magnet 152 connects to the base 156. The magnet is used to connect directly to the body panels of the vehicle 100. Lastly, the cylindrical connector 154 connects to the base 156 and is configured to hold, direct and control the path of the cord 130.

The cord 130 may be page from an organic material, cotton, nylon, plastic, polymer, polymer-like, braided or solid material. The cord is configured and structured to extend at least partially around the outer peripheral edge of the main body 104. The cord extends through the cylindrical connectors 154. In this embodiments, there is one cord extending around the outer peripheral edge of the main body 104. In other embodiments, a plurality of cords may be used. The cord 130 extends around the outer peripheral edge of the net 102, crosses through the connector handle 132, and is adjustable. The connector handle 132 includes a handle 134 having a hook or connector 136. The connector 136 allows the connector handle 132 to connect to a portion of the vehicle, such as a windshield wiper. The connector handle 132 may also include a magnet to secure the connector handle 132 to the exterior of the vehicle body 100. The connector handle includes a guide 138 allowing the cords 130 to pass therethrough. The guide 138 is generally a cylindrical tube allowing the cords to pass therethrough.

During use, the user drapes the entire net 102 over the vehicle. The user can then secure the cord 130 by cinching the cord (which passes through all of the cylindrical connectors 154) and securing it by the securement member 160.

The net 102 connects to the side view mirrors 114. The wire or bungee cords are configured to connect directly to the side view mirrors 114 by wrapping around the neck portion of the side view mirrors. In other embodiments, a wire or bungee cord may connect to an open window on a door, windshield wipers, or any other portion of the vehicle configured to have a protruding portion of allowing a cord to connect thereto. Alternatively, the connection portion is 122 to connect directly to a control arm or spring of the vehicle 100. The net 102 to the chassis of the vehicle 100 at the control arm. The net 102 having the main body 104 connects directly to the side view mirror 114 by means of a separate cord where in the cord is wrapped around the neck of the side view mirror 114.

In some embodiments, the connection portion 122 includes the grommet 152 or other reinforcement structure so as to improve where time and connection of the net 102 to the vehicle 100. The grommet 152 or eyelet may be a plastic, plastic like, polymer, Palmer Like, or metal material resilient enough to withstand significant airflow of an over the vehicle during transportation.

The net 102 is comprised of a net or mesh or mesh (142) like material typically made of a plastic, plastic like, polymer, or polymer like material having sufficient resiliency so as to sufficiently improperly contain debris that has fallen off of a vehicle during transportation. A secondary layer 140 is also provided.

In some embodiments, the net 102 has a main body 104 that is adapted and shaped to fit around in over a bumper, either front or rear, of a vehicle. In other embodiment, the net is a one piece material on formed were by the user is permitted to bend, mold, and adapt the net 102 to fit the shape of a vehicle.

In some embodiments, the connection portions are configured to include a strong magnet 152 which connects directly to the exterior of the vehicle 100. Inclusion of the magnets 152 negates the need for a cord or bungee to connect directly to the vehicle, or further supports any cord. However, in some embodiments, a cord or bungee may also be provided in addition to the magnets 152.

In other embodiments, the connection portion 122 connects to the vehicle 100 by means of a connector having a string portion and a bungee portion. Various other connectors, cords, bungees etc. may also be used to connect the net 102 to the vehicle 100.

The net 102 is further optionally stored in the basket 150. The basket 150 is made of a flexible tubing to form a containment area to hold a folded net 102 for quick access. The intention is to sell, hold, and store the entire basket 150 and net 102 configuration. The basket 150 includes the cage 153, connectors 155, cords 156, connector 158 and a metallic plate 162. The basket further includes magnets connected thereto to allow the basked to connect directly to the vehicle body. The basket 150 may also be secured by an adhesive, sticker, or the cords/bungees 156. An auxiliary light indicator 162 may be connected directly to the metallic plate 162 to serve as indicator lights for the vehicle being towed. These lights can be directional arrows, turn signals, hazard lights, reverse lights, brake lights . . . etc.

It is noted that the terms “substantially” and “about” may be utilized herein to represent the inherent degree of uncertainty that may be attributed to any quantitative comparison, value, measurement, or other representation.

These terms are also utilized herein to represent the degree by which a quantitative representation may vary from a stated reference without resulting in a change in the basic function of the subject matter at issue.

While particular embodiments have been illustrated and described herein, it should be understood that various other changes and modifications may be made without departing from the spirit and scope of the claimed subject matter.

Moreover, although various aspects of the claimed subject matter have been described herein, such aspects need not be utilized in combination.

It is therefore intended that the appended claims cover all such changes and modifications that are within the scope of the claimed subject matter.

1. A debris containment device for securing debris on a damaged vehicle, the debris containment device comprising:
a main body, the main body including a layer of netting;
a plurality of connection portions, at least one of the plurality of connection portions including a magnet configured to connect to the exterior of the vehicle, each connection portion including a grommet and a guide member; and
a cord extending around the outer peripheral edge of the main body, the cord extending though each guide member of each of the plurality of connection portions;
wherein the cord is configured to cinch the outer peripheral edge of the main body of the debris containment device so as to secure the debris containment device over a vehicle.

2. The debris containment device of claim 1 wherein the guide is a cylindrical tube positioned parallel with the edge of the main body.

3. The debris containment device of claim 1 wherein the cord connects to a handle portion by extending though the handle potion, the handle configured to connect to the vehicle.

4. The debris containment device of claim 1 wherein the main body includes secondary solid layer.

5. The debris containment device of claim 4 wherein the secondary solid layer is plastic.

6. The debris containment device of claim 1 wherein a basket is provided to store the debris containment device.

7. The debris containment device of claim 1 wherein the basket includes a metal plate thereby allowing a device to magnetically connect thereto.
